(19) United States
(12) Patent Application Publication
(10) Pub. No.: US 2018/0000058 A1
(43) Pub. Date: Jan. 4, 2018

(54) RATTLING SOFT BODY LURE

(71) Applicant: Joseph William Jarboe, JR., Fort Smith, AR (US)

(72) Inventor: Joseph William Jarboe, JR., Fort Smith, AR (US)

(73) Assignee: Plastic Research and Development Corporation, Birmingham, AL (US)

(21) Appl. No.: 15/638,732

(22) Filed: Jun. 30, 2017

Related U.S. Application Data
(60) Provisional application No. 62/357,313, filed on Jun. 30, 2016.

(51) Int. Cl. A01K 85/18; A01K 83/00; A01K 85/01; A01K 85/02

(52) U.S. Cl. CPC A01K 85/18; A01K 85/02; A01K 83/00; A01K 85/01

(57) ABSTRACT

A soft body lure design having a hard head which allows an internal rattle to create a much louder sound and maintain the balance of the lure and will also weigh more allowing the lure to be cast much farther

This application claims priority from U.S. Provisional Application Ser. No. 62/357,313 filed Jun. 30, 2016 entitled RATTLING SOFT BODY LURE.

### FIELD OF INVENTION

This invention relates to fishing lures and more particularly to lures that mimic an animate object in shape and also contain a rattle chamber to provide attractant noise to the target fish.

### BACKGROUND

Fisherman that are fishing in vegetation such as lily pads need to have a bait that is weedless, can be cast greater distance than any other rubber lure currently on the market, and has a rattle so the fish can locate the lure in heavy cover. All other soft bodied fishing lures do not emit much sound with the rattle inserted into the soft body. Furthermore, inserting a rattle into a soft body lure can also cause the balance of the product to be compromised.

I have solved these problems with a design having a hard head which allows the rattle to emit a much louder sound and maintain the balance of the lure and will also weigh more allowing the lure to be cast much farther.

### BRIEF DESCRIPTION OF THE DRAWINGS

Referring to the drawings which are appended hereto and which form a portion of this disclosure, it may be seen that:

FIG. 1 is perspective view of my improved rattling lure;

FIG. 2 is a front elevation view of the lure;

FIG. 3 is a rear elevation view of the lure;

FIG. 4 is a side elevational view of the lure;

FIG. 5 is an opposite side elevational view of the lure;

FIG. 6 is a top plan view of the lure;

FIG. 7 is a bottom plan view of the lure;

FIG. 8 is a sectional view of my improved rattling lure; and,

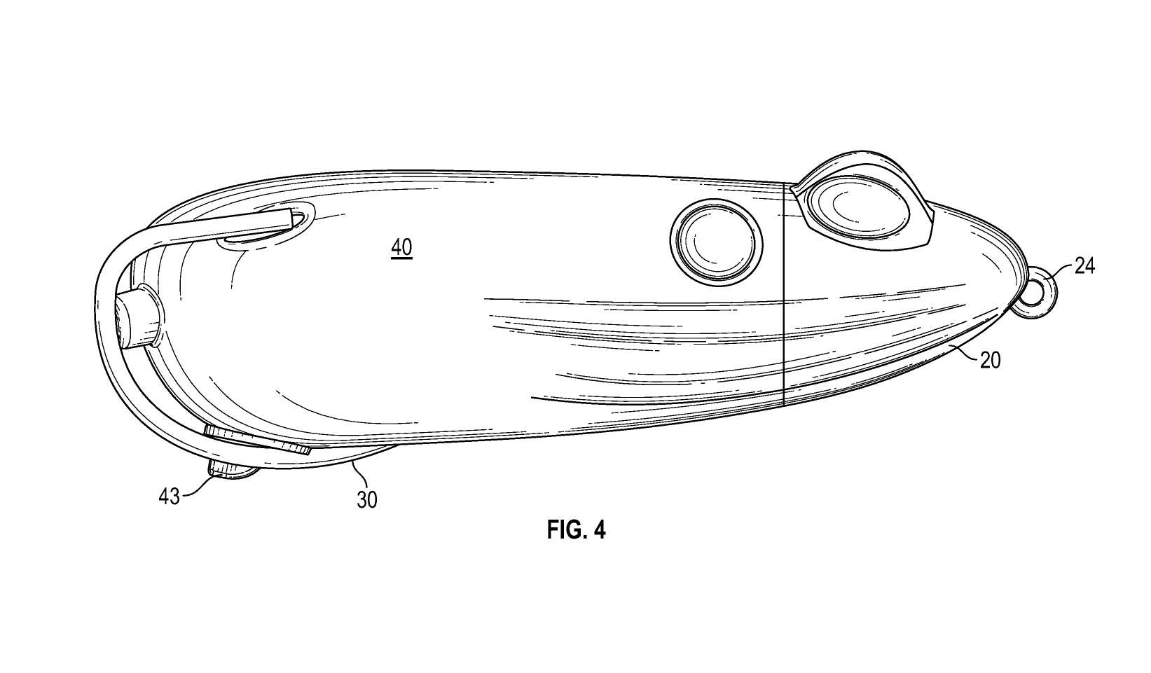

FIG. 3 is an exploded view of the improved rattling lure.

### DETAILED DESCRIPTION

One or more of the above objects can be achieved, at least in part, by providing a lure having the appearance of an animate object such as a frog or mouse that can be cast by a fisherman onto a set of floating pads such as lily pads in a body of water, or into the space between such pads. The fisherman then works the lure through and across the pads in hope that a large fish will attack the lure.

To accomplish this I have designed a lure 10 with a hard head 20 and a soft rubber body 40 with a rattle within the hard head 20. Specifically, the hard plastic or polycarbonate head 20 contains a free moving tungsten weight 21 within an internal chamber. The weight 21 is susceptible to inertial impact with the inside of the chamber thus creating a loud sound when hitting the side walls of the chamber 22 as the lure is worked over and through the pads.

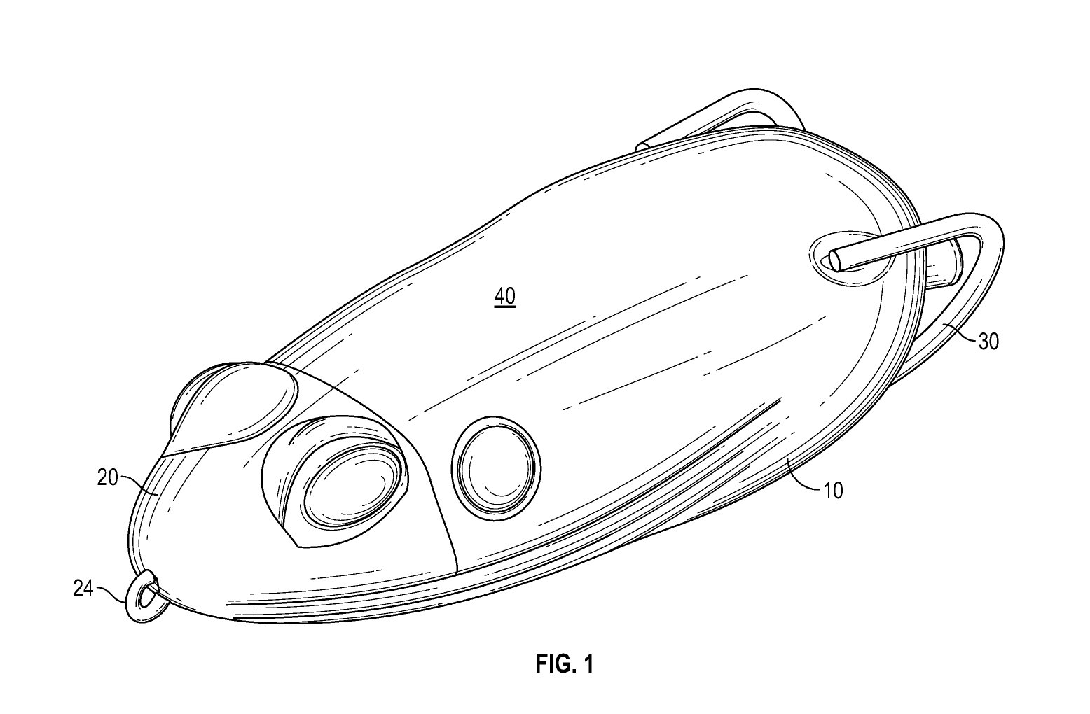

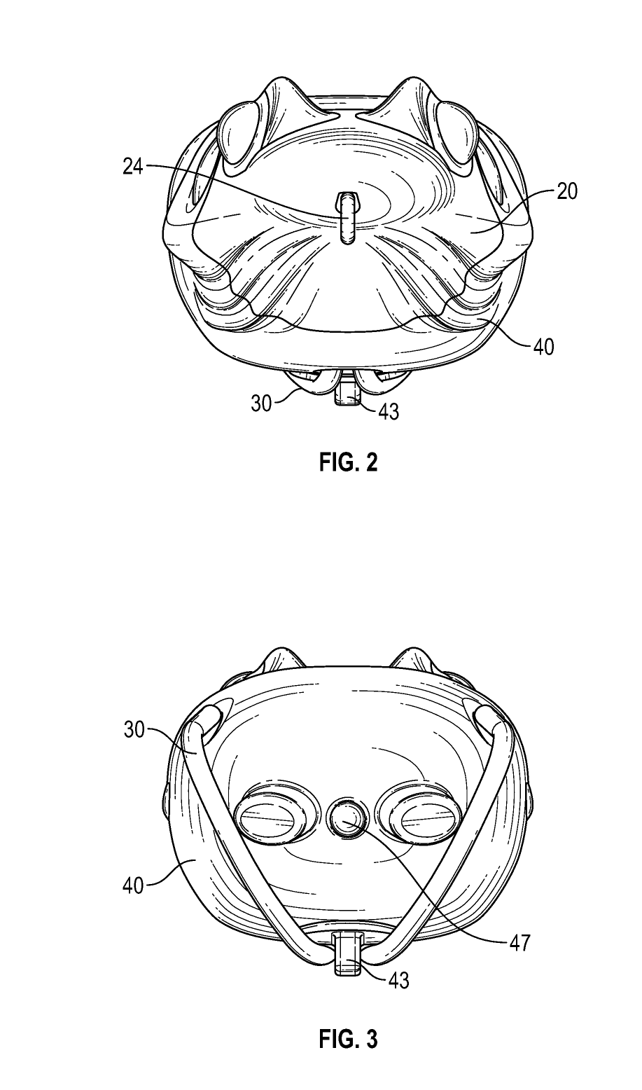

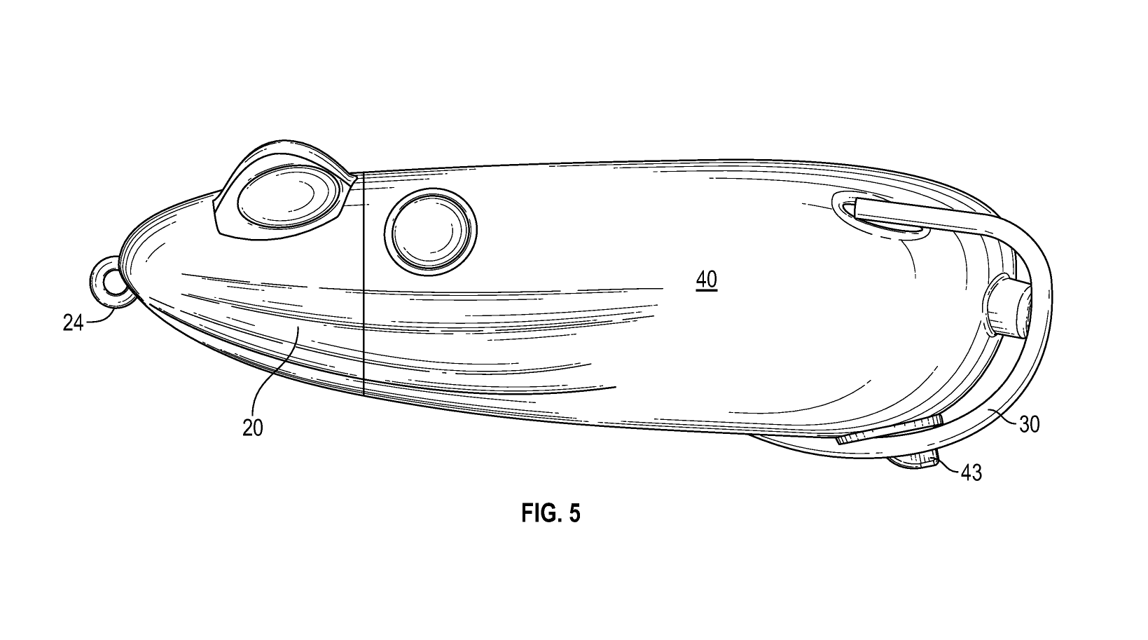

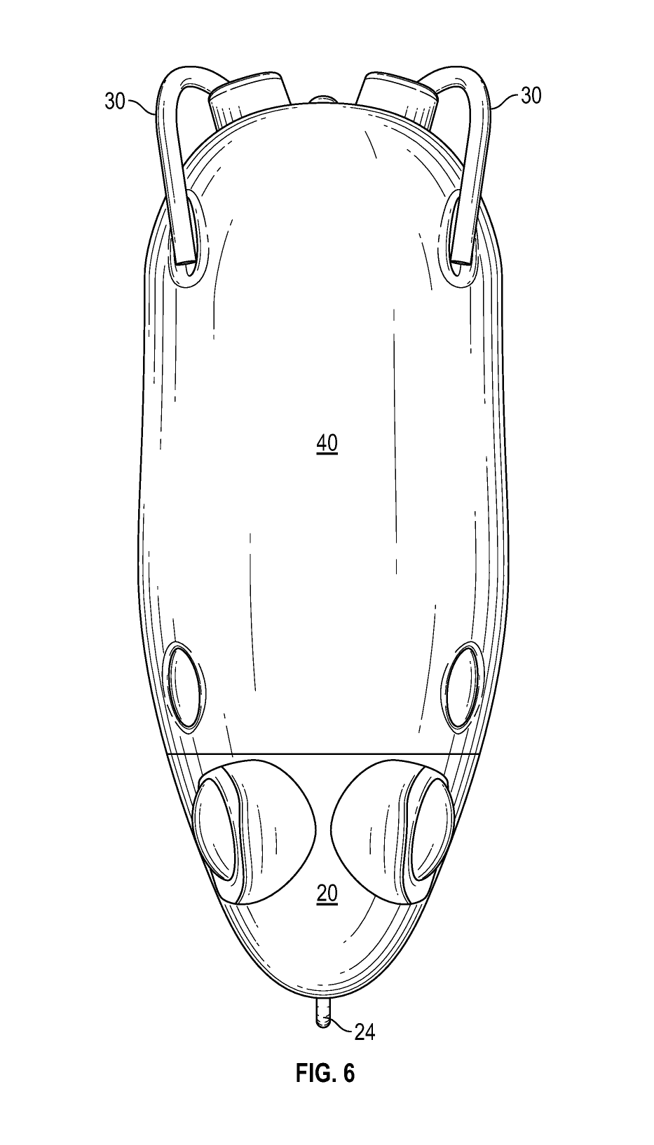

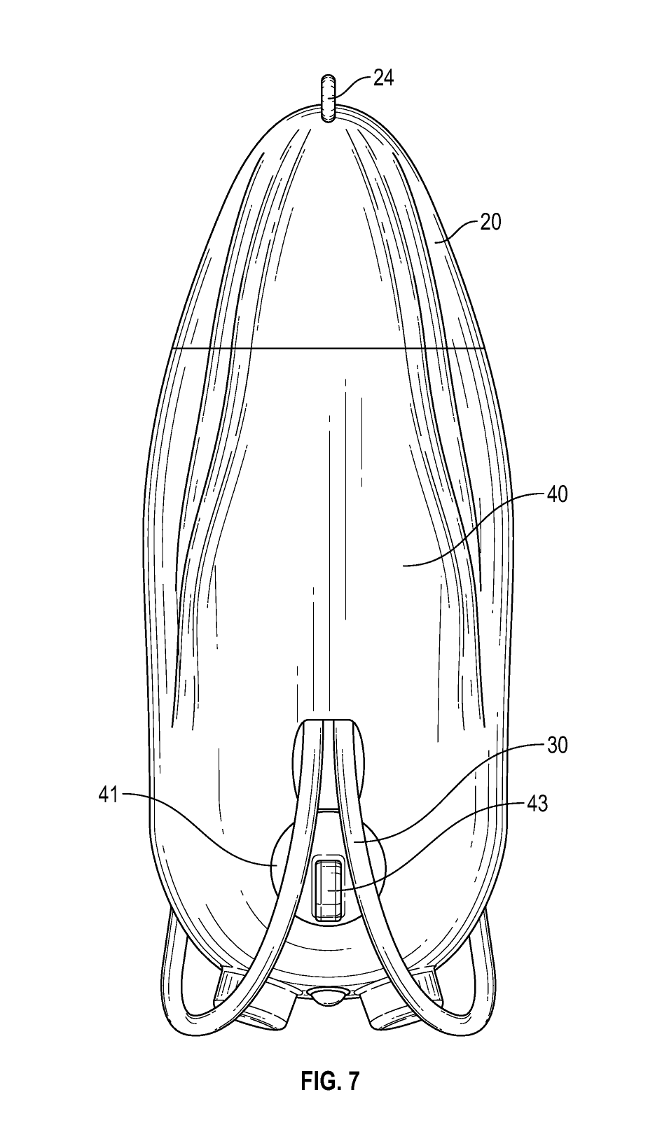

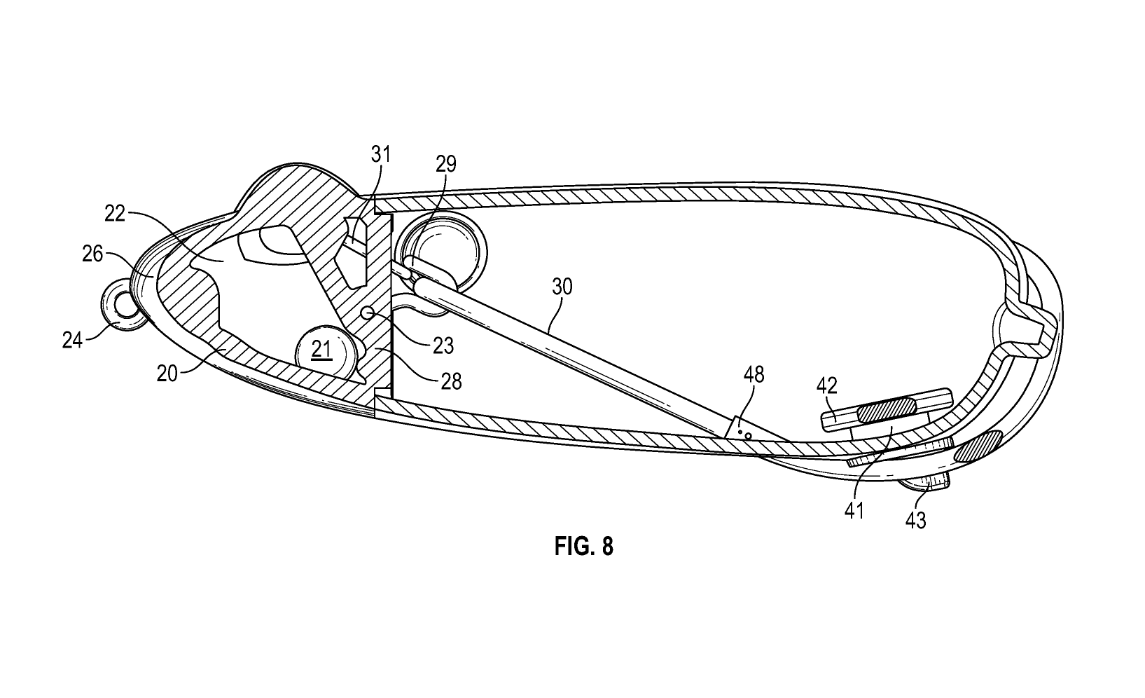

Referring to FIGS. 1 to 7 it may be seen that the soft body of the lure resembles a frog, however the body could easily resemble a mouse or even a small bird.

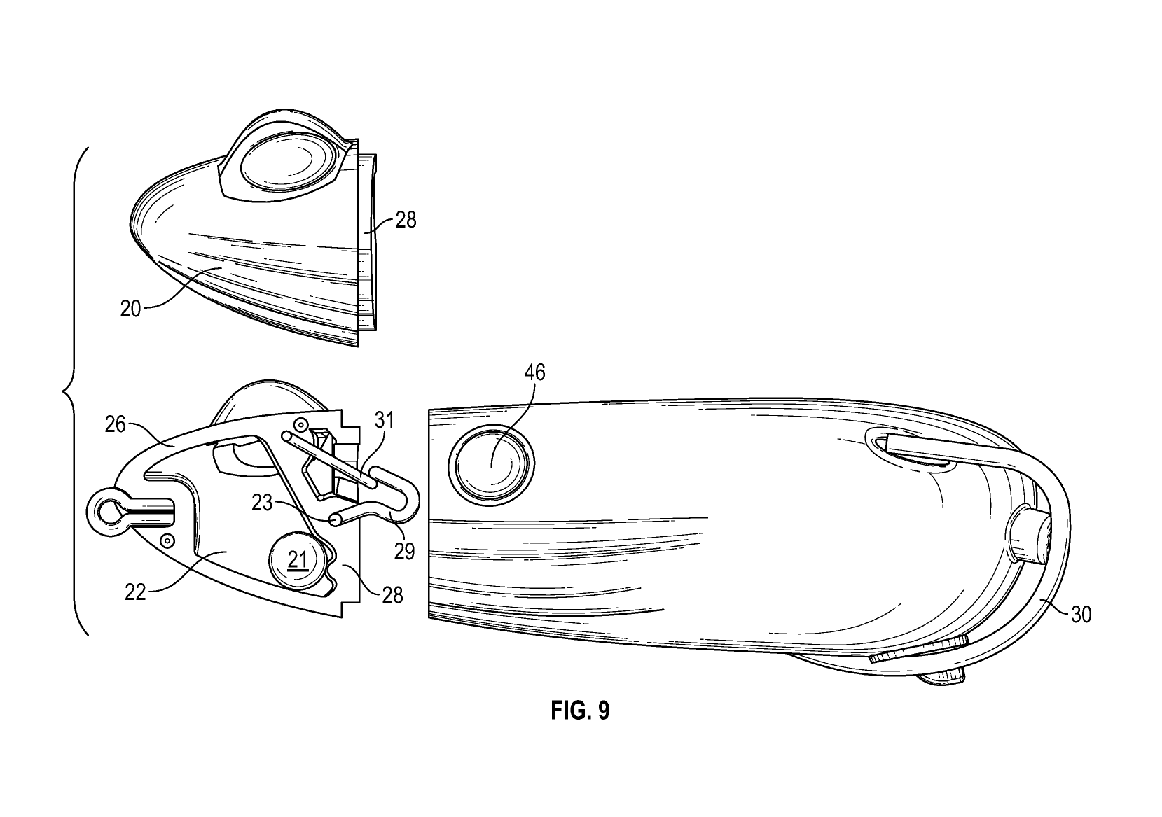

Another feature is designed to allow the hook to be assembled after the head and body is assembled and decorated. Referring to FIG. 8 and FIG. 9, note that the head 20 forms a hard plastic rattle chamber 22 with a custom wire-form 23 molded therein such that a pull-eye 24 extends from the front 26 of the molded head and a hook capture extends from the rear 28 of the molded head. The hook capture is in the nature of a J loop 29 closed by a spring steel hinge 31 that deflects when installing the hook and after the hook is installed the spring steel hinge 31 locks behind the hook as the hook nests in the J loop 29. The eyelet 32 of the hook 30 may be engaged with the J loop 29 with the shank(s) 33 of the hook extending through the soft body 40.

Referring to FIGS. 1, 3, 6 and 7, it will be noted that the hook 30 itself is a preferably double shank spread barb hook with the shanks passing on either side of a tail weight 41 which is used to balance the lure 10 for tracking purposes. The weight 41 has a portion 42 molded inside the soft body and a V shaped feature 43 designed on a portion extending outside the body 40 to fit between the shanks 33 to facilitate the hook 30 staying in a good relative location to maximize the opportunity to hook up a fish when it strikes the lure. The body 40 may also be designed with vents 46 and 47 which enable water which may get into the lure body 40 to be expelled and which also allow the body to collapse when a strike occurs so that the hook 30 may more readily engage the fish.

The combination of the weight of the head, the body and the weights 21 and 41 give the lure added heft such that it can be cast further than the prior art lures of this type. The rubber material of the body 40 should be sufficiently resilient to withstand long distance casting impacts by deforming on impact and returning to its anatomical shape, however it may be necessary to include strategically placed gussets inside the body to assist with maintaining the body shape.

As seen in FIGS. 8 and 9, the hard head 20 is molded in two pieces and the weight 21 or rattle inserted into the chamber. The head 20 is affixed to the soft body 40 with a rubber adhesive so the seal between the head and body will not leak. Likewise, rubber sleeves 48 may be formed internally of body 40 to provide a seal where the hook shanks pass through the body wall. These sleeves 48 also serve as gussets which assist in maintaining the body shape by closely engaging the hook shanks and maintaining the relative position of the hooks in the body.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A fishing lure comprising a hard head forming a rattle chamber adhered to a soft lure body, a movable weight captured within said rattle chamber and responsive to movement of the fishing lure to create sound such that the soft body lure can achieve maximum sound transmission from the rattle chamber and weight, said hard head having a wire form molded therein to provide a pull point and hook connection.

2. A fishing lure as defined in claim 1 wherein said soft body has an anatomical shape selected from the shape of a mouse or frog.

3. A fishing lure as defined in claim 1 wherein said hook connection comprises a J loop closed by a spring steel hinge.

4. A fishing lure as defined in claim 3 further comprising a hook extending through said soft body and having an eye connected to said J loop and at least one barb lying proximal an outside surface of said soft body.

5. A fishing lure as defined in claim 4 further comprising sleeves integral with said soft body through which said hook passes to provide a seal.

6. A fishing lure as defined in claim 3 wherein said hook is a double shank spread barb hook.

7. A fishing lure as defined in claim 6 further comprising a tail weight molded to said body and having a portion thereof external to said body having a V shape to engage said double shank spread barb hook between the double shanks thereof to maintain said hook in alignment with said soft body.

8. A fishing lure as defined in claim 6 wherein said soft lure body is hollow and includes vents for expelling water that may be inside said soft lure body.

9. A fishing lure as defined in claim 6 wherein said body includes internal sleeves closely engaging said double shanked barbed hook where said hook extends through said body.

10. A fishing lure as defined in claim 1 wherein said soft lure body is hollow and includes vents for expelling water from inside said soft lure body.
